(19) United States
(12) Patent Application Publication
(10) Pub. No.: US 2008/0292126 A1
(43) Pub. Date: Nov. 27, 2008

(54) HEARING ASSISTANCE DEVICE WITH CAPACITIVE SWITCH

(75) Inventors: Michael Karl Sacha, Chanhassen, MN (US); Sidney A. Higgins, Maple Grove, MN (US)

Correspondence Address: SCHWEGMAN, LUNDBERG & WOESSNER, P.A., P.O. BOX 2938, MINNEAPOLIS, MN, 55402, US

(73) Assignee: Starkey Laboratories, Inc., Eden Prairie, MN (US)

(21) Appl. No.: 12/126,779

(22) Filed: May 23, 2008

Related U.S. Application Data
(60) Provisional application No. 60/940,041, filed on May 24, 2007.

(51) Int. Cl. H04R 25/00

(52) U.S. Cl. 381/330; 381/322; 381/312

(57) ABSTRACT

Disclosed herein, among other things, is a hearing assistance device apparatus with a capacitive switch. According to various embodiments, the apparatus includes a BTE housing, hearing assistance electronics housed in the housing and a capacitive switch connected to the hearing assistance electronics and adapted to detect a wearer when the BTE housing is worn.

### RELATED APPLICATION

This application claims the benefit of U.S. Provisional Patent Application Ser. No. 60/940,041 filed May 24, 2007, which is incorporated by reference herein.

### FIELD OF THE INVENTION

The present patent application relates to switches used in hearing assistance devices, and in particular to a hearing assistance device with one or more capacitive switches.

### BACKGROUND

Hearing assistance devices include hearing aids, and other devices which benefit hearing. In the case of hearing aids, some of the more generally important design considerations include low power consumption, limited and sometimes difficult dimensions, ease of manufacture, comfort, and ease of use. One area of particular concern is how to operate hearing aids devices in view of shrinking package sizes, limited power, and an increasingly more adult population with limited or diminishing manual dexterity.

There is a need in the art for improved switches that afford a user easy switching without false switching, and which will not be wasteful of power.

### SUMMARY

The present application provides, in one aspect, a hearing assistance device for a wearer comprising a behind-the-ear (BTE) housing, hearing assistance electronics housed in the housing and a capacitive switch connected to the hearing assistance electronics, the capacitive switch adapted to detect the wearer when the BTE housing is worn. According to another aspect of the present application, a hearing assistance device for a wearer is provided, the device comprising a housing, hearing assistance electronics housed in the housing; and a capacitive switch connected to the hearing assistance electronics, the capacitive switch having metallized electrodes, the electrodes adapted to shield at least a portion of the hearing assistance device electronics from electromagnetic interference.

### BRIEF DESCRIPTION OF THE DRAWINGS

FIG. 1A shows a hearing assistance device according to one embodiment of the present subject matter.

FIG. 1B shows a hearing assistance device according to one embodiment of the present subject matter.

FIG. 2A and FIG. 2B illustrate the effect of sweeping a finger in a volume up and volume down direction using a hearing assistance device according to one embodiment of the present subject matter.

FIG. 3A and 3B show a hearing assistance device with capacitive sensor to be used to determine when a user has the hearing aid on his or her ear according to one embodiment of the present subject matter.

FIG. 4A and 4B show a hearing assistance device with capacitive sensor to be used to determine when a user has the hearing aid on his or her ear according to one embodiment of the present subject matter.

FIGS. 5A and 5B show a hearing assistance device with a capacitive switch for cycling through memory counter or volume counter according to one embodiment of the present subject matter.

FIGS. 6A, 6B, and 6C demonstrate an in-the-ear hearing assistance device with a single memory function capacitive switch according to one embodiment of the present subject matter.

### DETAILED DESCRIPTION

This disclosure describes how capacitive sensor technology is applied to hearing assistance devices, including hearing aids, for switch sensing applications. Advances in capacitive sensing technology provide beneficial voltage requirements and very low current consumption. The operating principle is based on charge transfer between two conducting surfaces placed in close proximity. The two surfaces are any conductive material, including, but not limited to, metals and conductive inks. The two surfaces can be arranged in a variety of sizes and shapes. A circuit generates a specific electric signal that is sent to one surface called the drive electrode. In one embodiment, the circuit is an integrated circuit (IC). A resultant electric field is generated between this drive electrode and a receive electrode. As a conducting body enters this field (between electrodes) a variable signal results at the receive electrode that the IC interprets as a “switch” actuation. The cost of this IC is relatively minimal and is in line with mass produced IC's. The motivations for adapting charge transfer (capacitance) sensing technology within hearing aids are many fold. In certain realizations of this switch design, the switch is much lower in cost than conventional switches since it can be made for less than a dollar per switch. (Present hearing aid switch technology (electromechanical) ranges in price from $2.00 for a simple push button, to $3.00 for a potentiometer.) Capacitive sensing technology is more reliable because there are no moving parts to fail or wear. Capacitive switch designs can reduce or eliminate case ingress due to conventional electromechanical controls. Dirt and moisture entry compromises hearing aid reliability. The elimination of contaminant entry points makes possible the manufacture of water resistant hearing aids.

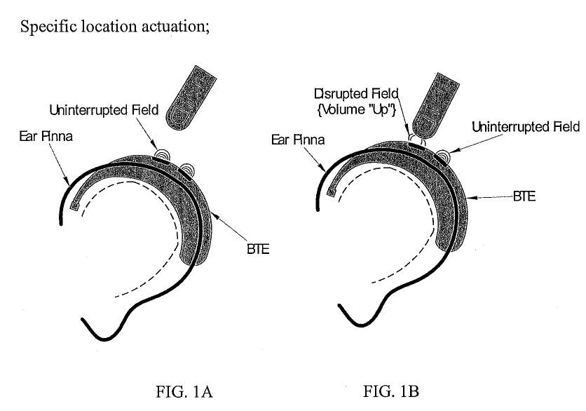

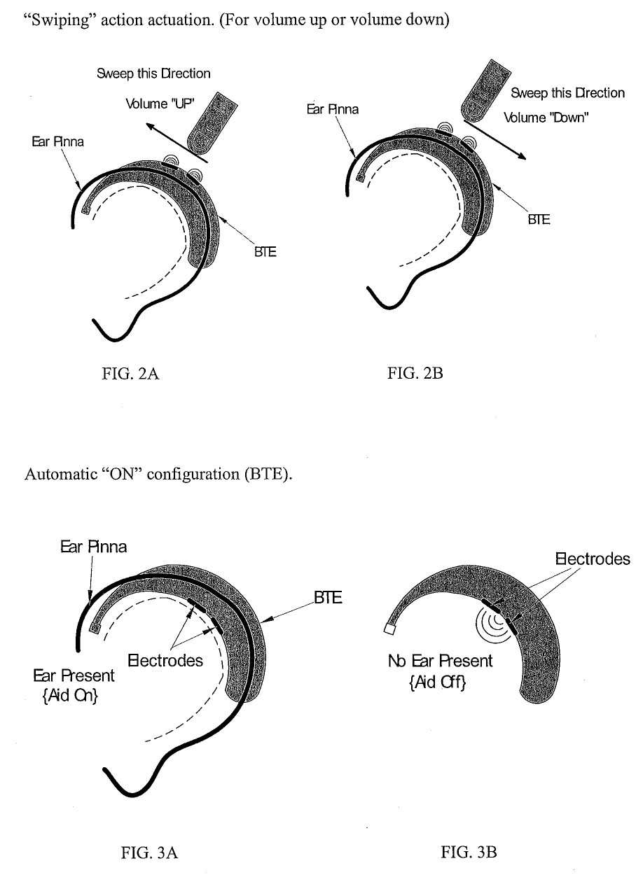

Depending on the placement of the sensing electrodes on the hearing aid, new ways of user interaction are possible. The user could “locate” a specific area on the aid to initiate an action (as is presently done), or, use a swiping/brush like motion. This latter mode would eliminate the necessity for an elderly user, with limited dexterity, to specifically locate and manipulate a small target. FIG. 1A shows a hearing aid application which, only for the sake of demonstration, is a behind-the-ear or BTE technology. It is understood that the capacitive switch technology could be used in any number of hearing assistance designs, and any type of hearing aid. Thus, the technology could be used in behind-the-ear, in-the-ear, in-the-canal, and completely-in-the canal designs. FIG. 1B shows a disrupted field when the user's finger is in close enough proximity to the electrodes. FIG. 2A and FIG. 2B demonstrate the effect of sweeping a finger in a volume up and volume down direction, respectively. It is understood that many configurations may be employed and that the positions or directions of movement may vary without departing from the scope of the invention. Furthermore, the nature of the fields can be changed which can affect how close the finger must be to the surfaces of the switches. For example, in some embodiments the finger will touch the surface of the hearing aid to effect a switch function.

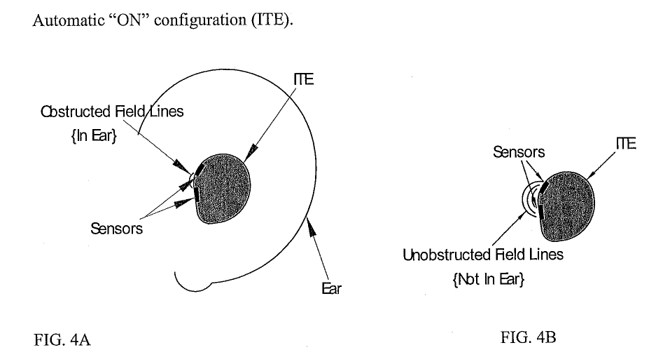

FIG. 3A shows a capacitive sensor to be used to determine when a user has the hearing aid on his or her ear. In FIG. 3A the aid is on the ear, so the hearing aid senses the ear. In FIG. 3B the aid is separate from the ear and no longer senses the ear. Thus, in one embodiment this switch can be used to turn the hearing aid off. This allows for increased battery power savings as the aid is only on when in use. If a user forgets to turn off the hearing aid when not in use, this approach will automatically perform the “on” and “off” functions. The switch can serve in some embodiments as an automatic “on” detector. This same functionality (automatic “ON”) can be created in an ITE hearing device. (FIGS. 4A and 4B) In this embodiment, the sensors are adapted to touch the inner portion of the ear canal when inserted to perform the switching operation.

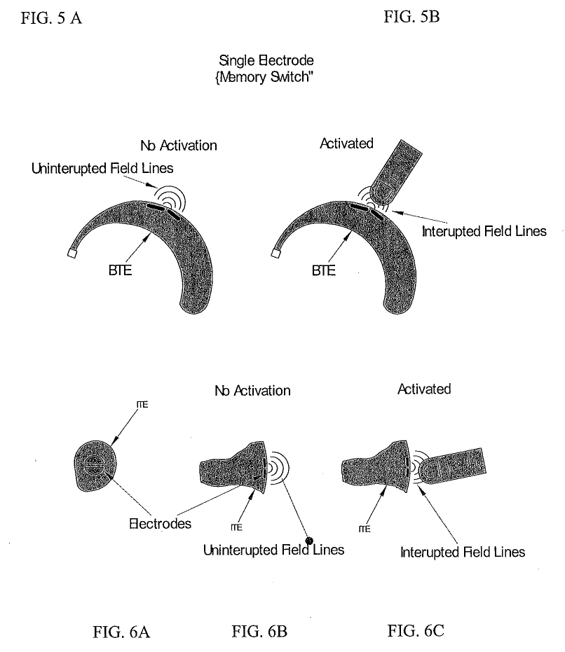

In some embodiments a single memory switch function is possible. FIGS. 5A and 5B demonstrate hearing aid configurations where a single memory switch function is performed. In this application a single sensing element is used to cycle through a memory counter or volume control counter. Other functions may be implemented with this design and the examples given herein are not intended to be limiting or exclusive. It is understood that this design is not limited to a BTE approach and that other hearing assistance devices may employ this design without departing from the scope of the present subject matter.

FIGS. 6A, 6B, and 6C demonstrate a single memory function in an in the ear application. The electrodes at the end of the ITE can be switched with a finger as shown.

Other electrodes and electrode positions may be employed without departing from the scope of the present subject matter. With capacitive sensor technology, new and unique styling options can be realized. The added metallization (electrodes) could also provide protection from cell phone hearing aid interference by acting as a shield to electromagnetic radiation. Additional features can be supported with this technology. Multiple sensors, including, but not limited to, up/down volume control, telecoil switching, and/or memory select, can enable second function capability for the user or audiologist. This would enable, for example, the audiologist to access hearing aid parameters that would normally only be available at an audiologist's office via a hearing aid programmer.

Another advantage of the present subject matter is that the elimination of bulky electromechanical controls frees up valuable internal volume.

It is understood that many configurations may be employed and that the positions or directions of movement may vary without departing from the scope of the invention. Different electrode positions and geometries can be employed. Furthermore, the nature of the fields can be changed which can affect how close the finger must be to the surfaces of the switches. For example, in some embodiments the finger will touch the surface of the hearing aid to effect a switch function. Other applications can be performed and those listed herein are not intended to be exhaustive or exclusive.

What is claimed is:

1. A hearing assistance device for a wearer, the device comprising:
a behind-the-ear (BTE) housing; and
hearing assistance electronics housed in the housing;
a capacitive switch connected to the hearing assistance electronics, the capacitive switch adapted to detect the wearer when the BTE housing is worn.

2. The device of claim 1, wherein the hearing electronics are adapted to automatically turn “off” when the capacitive switch fails to detect the wearer.

3. The device of claim 2, wherein the hearing electronics are adapted to automatically turn “off” a predetermined interval of time after the capacitive switch fails to detect the wearer.

4. The device of claim 1, further comprising a second capacitive switch connected to the hearing assistance electronics and adapted to generate a switch signal when touched.

5. The device of claim 4, wherein the hearing assistance electronics are adapted to adjust a volume of the hearing assistance electronics in response to the switch signal.

6. The device of claim 4, further comprising at least one additional capacitive switch, wherein the hearing assistance electronics are adapted to execute a function when the second capacitive switch and the at least one addition capacitive switch are triggered according to a predetermined sequence.

7. The device of claim 6, wherein the function allows access to parameters normally available to an audiologist.

8. The device of claim 1, wherein the capacitive switch includes two surfaces of conductive ink.

9. A hearing assistance device for a wearer comprising:
a housing;
hearing assistance electronics housed in the housing; and
a capacitive switch connected to the hearing assistance electronics, the capacitive switch having metallized electrodes, the electrodes adapted to shield at least a portion of the hearing assistance device electronics from electromagnetic interference.

10. The device of claim 9, wherein the capacitive switch is adapted to detect the wearer when the housing is worn.

11. The device of claim 10, wherein the hearing electronics are adapted to automatically turn “off” when the capacitive switch fails to detect the wearer.

12. The device of claim 10, wherein the hearing electronics are adapted to automatically turn “off” a predetermined interval of time after the capacitive switch fails to detect the wearer.

13. The device of claim 9, wherein the capacitive switch is adapted to generate a switch signal when touched.

14. The device of claim 13, wherein the hearing assistance electronics are adapted to adjust a volume of the hearing assistance electronics in response to the switch signal.

15. The device of claim 13, wherein the hearing assistance electronics are adapted to select a parameter of the hearing assistance electronics in response to the switch signal.

16. The device of claim 13, further comprising at least one additional capacitive switch, wherein the hearing assistance electronics are adapted to execute a function when the capacitive switch and the at least one addition capacitive switch are triggered according to a predetermined sequence.

17. The device of claim 16, wherein the function allows access to parameters normally available to an audiologist.

18. The device of claim 9, wherein the housing is a BTE housing.

19. A hearing assistance device comprising:
a telecoil;
a microphone;
hearing assistance electronics connected to the telecoil and the microphone, the hearing assistance electronics adapted to generate an output signal; and
a capacitive sensor connected to the hearing assistance electronics, the capacitive sensor adapted to trigger the hearing assistance electronics to generate the output signal based on an input signal received from the telecoil when the capacitive sensor is triggered.

20. The device of claim 19, wherein the capacitive sensor includes two conductive ink surfaces.

21. The device of claim 19, further comprising a capacitive switch connected to the hearing assistance electronics, the capacitive switch adapted to generate a switch signal when touched.

22. The device of claim 21, wherein the hearing assistance electronics are adapted to adjust a volume of the hearing assistance electronics in response to the switch signal.

23. The device of claim 21, wherein the hearing assistance electronics are adapted to select a parameter of the hearing assistance electronics in response to the switch signal.

24. The device of claim 21, further comprising at least one additional capacitive switch, wherein the hearing assistance electronics are adapted to execute a function when the capacitive switch and the at least one addition capacitive switch are triggered according to a predetermined sequence.

25. The device of claim 24, wherein the function allows access to parameters normally available to an audiologist.
